(19) United States
(12) Patent Application Publication
(10) Pub. No.: US 2017/0024785 A1
(43) Pub. Date: Jan. 26, 2017

(54) VEHICLE ESTIMATING SYSTEM THAT PROVIDES FEATHER PRIME AND BLOCK DATA

(71) Applicant: Audatex North America, Inc., San Diego, CA (US)

(72) Inventor: Frederic D. Bersot, Reno, NV (US)

(21) Appl. No.: 15/209,533

(22) Filed: Jul. 13, 2016

Related U.S. Application Data
(60) Provisional application No. 62/194,760, filed on Jul. 20, 2015.
(60) Provisional application No. 62/198,658, filed on Jul. 29, 2015.

(51) Int. Cl. G06Q 30/02; G06Q 40/08

(52) U.S. Cl. CPC G06Q 30/0283; G06Q 40/08

(57) ABSTRACT

An apparatus and method for generating a repair estimate. The apparatus includes an input for receiving user input and a processor that generates one or more estimate screens with an FPB material field and an FPB labor time field. The processor receives input related to the FPB material and input related to the FPB labor time fields, and generates a repair estimate that list the FPB material input and the FPB labor time input.

### CROSS-REFERENCE TO RELATED APPLICATIONS

This application claims the benefit of U.S. patent application No. 62/194,760 filed on Jul. 20, 2015 and U.S. patent application No. 62/198,658 filed on Jul. 29, 2015, both of which are incorporated herein in their entirety.

### BACKGROUND OF THE INVENTION

1. Field of the Invention

The subject matter disclosed generally relates to a method and system for generating a repair estimate for a damaged vehicle.

2. Background Information

When a vehicle such as an automobile is damaged the owner may file a claim with an insurance carrier. A representative typically inspects the vehicle to determine the amount of damage and the costs required to repair the automobile. The owner of the vehicle or the vehicle repair facility may receive a check equal to the estimated cost of the repairs. If the repair costs exceed the value of the automobile, or a percentage of the car's value, the representative may “total” the vehicle. The owner may then receive a check based on the value of the automobile.

The repair costs and other information may be entered by the representative into an estimate report. After inspection the representative sends the estimate report to a home office for approval. To improve the efficiency of the claims process there have been developed computer systems and accompanying software that automate the estimate process. By way of example, the assignee of the present invention, Audatex, Inc., (“Audatex”) provides a software product under the trademark Audatex Estimating that allows a representative to enter claim data. The product will display parts list that can be selected by the estimator to build an estimate to repair the vehicle. The software will automatically list the price of any selected part with associated labor cost. There are typically fields that allow for a cost estimate to paint or otherwise refinish a vehicle panel.

Refinishing a panel may include a process referred to as feather, prime and block (“FPB”) that includes the step of spraying a primer onto the panel. The EPA has issued a rule that defines whether a FPB process should be conducted in a controlled paint facility. In the estimate, the FPB operation is typically included in the body repair labor as opposed to refinish labor. Repairers are concerned that such a characterization of the FPB procedure may expose them to liability for violation of the EPA rule on the facility required to perform a paint procedure. Moving the FPB operation into the refinish labor category may cause the associated FPB material cost to be inappropriately included in the cost of paint and materials.

### BRIEF SUMMARY OF THE INVENTION

An apparatus and method for generating a repair estimate. The apparatus includes an input for receiving user input and a processor that generates one or more estimate screens with an FPB material field and an FPB labor time field. The processor receives input related to the FPB material and input related to the FPB labor time fields, and generates a repair estimate that list the FPB material input and the FPB labor time input.

### BRIEF DESCRIPTION OF THE DRAWINGS

FIG. 1 is a schematic of a system that can be used to create a repair estimate for a damaged vehicle;

FIG. 2 is a schematic of an architecture for a server of the system;

FIG. 3 is an illustration of an estimate screen having a field that allows for entry of an FPB materials cost;

FIG. 4 is an illustration of an estimate screen having a field that allows for entry of an FPB labor time; and,

FIG. 5 is an illustration of an estimate screen showing the FPB materials and labor time as separate estimate line items.

### DETAILED DESCRIPTION

Disclosed is a system and method for generating repair estimate for a damaged vehicle that includes separate line items for FPB materials and labor time.

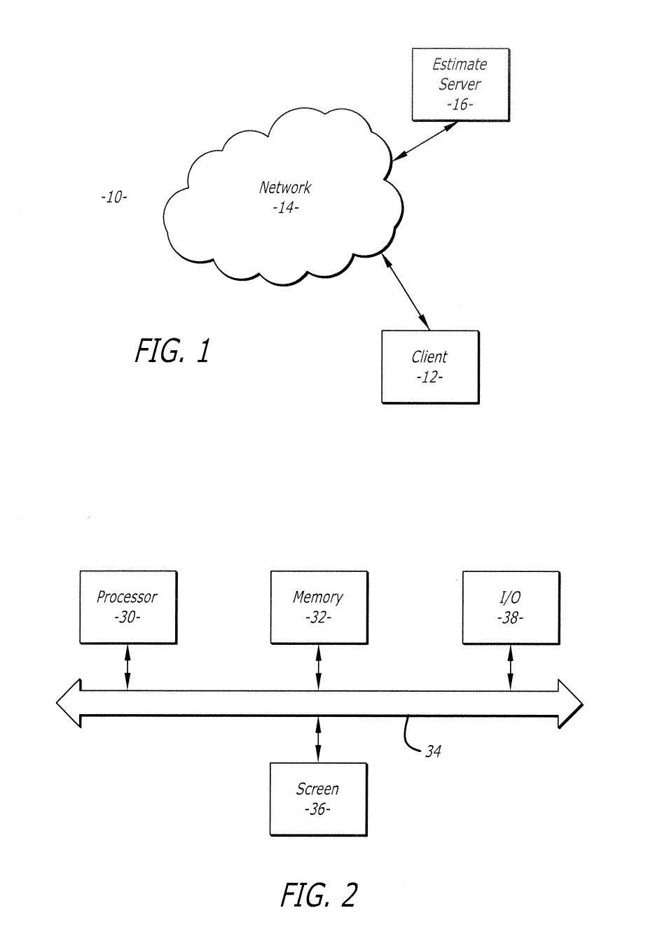

Referring to the drawings more particularly by reference numbers, FIG. 1 shows a system 10 that can be used to generate a repair estimate for a damaged vehicle. The system 10 may include at least one client 12 that is connected to an electronic communication network 14. The electronic communication network 14 may be a wide area network (WAN) such as the Internet. Accordingly, communication may be transmitted through the network 14 in TCP/IP format. The client 12 could be any type of device, such as a computer, that can access the network 14.

The system 10 may further include a claim server 16 connected to the network 14. The claim server 16 may provide a web based portal that provides access to a repair cost estimate web site. The web site may provide one or more web pages that can be used by a representative to generate a repair cost estimate. By way of example, the representative may utilize the web pages to determine the estimate. Although one claim server 16 is shown, it is to be understood that the claim server may include two or more separate servers including a web server and an application server that together perform various functions.

FIG. 2 shows an overall architecture of the client 12 and/or server 16. The architecture includes a processor 30 connected to one or more memory devices 32 through a bus 34. The memory device 32 may include both volatile and non-volatile memory such as read only memory (ROM) or random access memory (RAM). The processor 30 is capable of operating software programs in accordance with instructions and data stored within the memory device 32. Without limiting the scope of the invention the term computer readable medium may include the memory device 32. The computer readable medium may contain software programs in binary form that can be read and manipulated by the processor 30.

The architecture further includes a screen 36 and an input/output (I/O) 38 to communicate with external sources.

The server 16 may contain relational databases that correlate data with individual data fields and a relational database management system (RDBMS). The RDBMS of the server 16 may include a reference to a website that can be accessed by the client 12. The website has one or more specific uniform resource locators (URL) that can be used to access the site through the network 14. The URL can be entered through a web-based application resident in the client computer 12. By way of example, the web based application may be a browser. Server 16 contain databases and algorithms that generate a repair estimate by displaying one or more estimate screens and receiving input from a user.

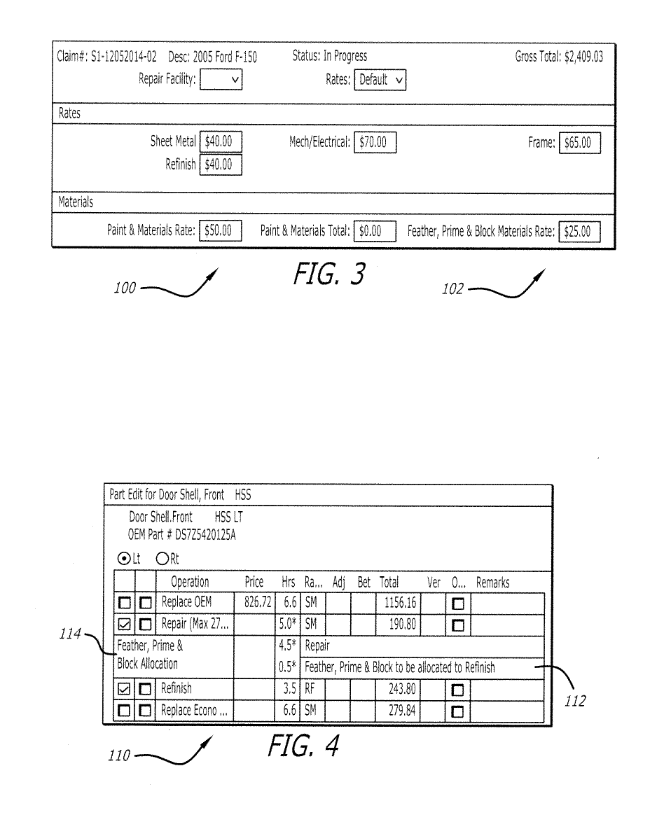

As shown in FIG. 3 the system may display an estimate screen 100 that includes a Feather, Prime & Block Material Rate field 102. The field 102 may allow for the manual entry of the materials cost for a FPB process in vehicle repair. The Feather, Prime & Block Material Rate field 102 may be displayed with other materials fields, such as paint and materials, and sheet metal costs. The estimate screen 100 is displayed as part of a software estimating system that is utilized by an operator to generate an estimate to repair a damaged vehicle.

FIG. 4 shows another estimate screen 110 that includes a Repair field 112 that provides an estimate on the amount of time required to perform a specified repair. The screen 110 also includes a Feather, Prime & Block Allocation field 114 that provides an allocation of the time required to perform the FPB process. The time can be manually entered by the operator. The system automatically allocates the FPB labor time from the overall repair time. For example, as shown the operator has entered an overall repair labor time of 5 hours. The operator has also allocated 0.5 hours to FPB. The system automatically subtracts the FPB time from the overall repair time entered by the estimator (e.g. 4.5 hours).

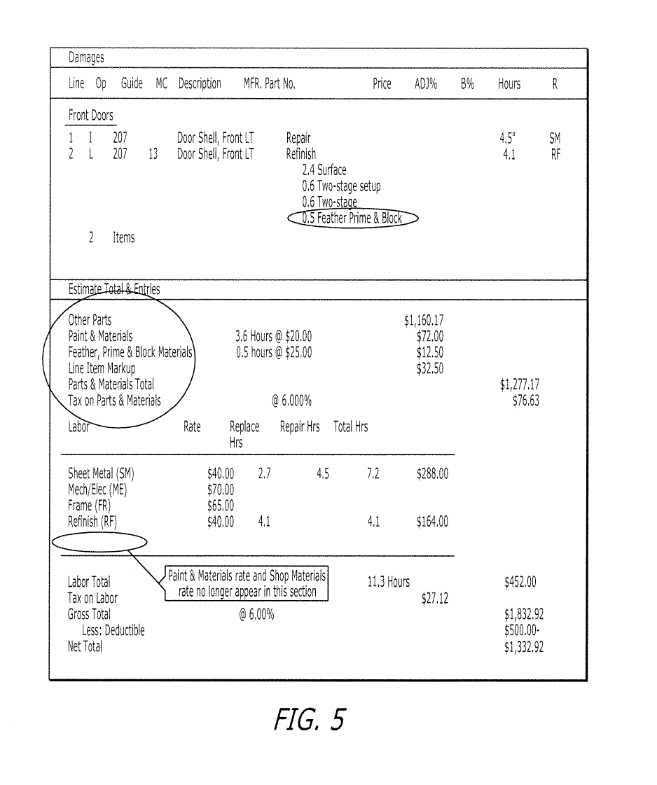

As shown in FIG. 5 the system will display another estimate screen 120. This estimate screen provides an estimate to repair a vehicle. The estimate includes separate line items for the FPB labor allocation and the FPB materials cost. With these separate line items the FPB process can accurately be included in the estimate for any vehicle estimate.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus that provides a repair estimate for a damaged vehicle, comprising:
an input for receiving user input; and,
a processor that generates one or more estimate screens with an FPB material field and an FPB labor time field, said processor receives input related to the FPB material and input related to the FPB labor time fields, and generates a repair estimate that list the FPB material input and the FPB labor time input.

2. The apparatus of claim 1, wherein said processor subtracts the FPB labor time input from an overall labor time to repair the vehicle.

3. A non-transitory computer program storage medium, comprising computer-readable instructions for providing a repair estimate for a damaged vehicle, execution of said computer-readable instructions by at least one processor performs the steps:
displaying one or more estimate screens that include an FPB material field and an FPB labor time field;
receiving input related to the FPB material and input related to the FPB labor time fields; and,
generating a repair estimate that list the FPB material input and the FPB labor time input.

4. The non-transitory computer program storage medium of claim 3, wherein the FPB labor time input is subtracted from an overall labor time to repair the vehicle.

5. A method for providing a repair estimate for a damaged vehicle, comprising;
displaying one or more estimate screens generated by a processor that include an FPB material field and an FPB labor time field;
receiving input related to the FPB material and input related to the FPB labor time fields; and.
generating, by the processor, a repair estimate that list the FPB material input and the FPB labor time input.

6. The method of claim 5, further comprising subtracting the FPB labor time input from an overall labor time to repair the vehicle.
